(19) United States
(12) Patent Application Publication
(10) Pub. No.: US 2025/0198817 A1
(43) Pub. Date: Jun. 19, 2025

(54) HIGH SENSITIVITY ULTRASONIC FLOW METER

(71) Applicant: SENTINEL HYDROSOLUTIONS, LLC, Escondido, CA (US)

(72) Inventors: SEAN SCRUGGS, San Diego, CA (US); Jonathan Naveh, San Diego, CA (US)

(21) Appl. No.: 18/962,697

(22) Filed: Nov. 27, 2024

Related U.S. Application Data
(63) Continuation of application No. 17/741,405, filed on May 10, 2022, now Pat. No. 12,174,050.
(60) Provisional application No. 63/186,789, filed on May 10, 2021.

(51) Int. Cl. G01F 1/667; G01F 25/10

(52) U.S. Cl. CPC G01F 1/667; G01F 25/10

(57) ABSTRACT

Methods for Ultrasonic Flow Metering, Ultrasonic Flow Meter Calibration, and Ultrasonic Fluid Characterization. Focusing on the governing principles and equations of flow measurement for ultrasonic flow meters, using temperature referenced differential and absolute time of flight measurements to characterize fluid motion. As well as, experimental solutions to meter calibration constants, thermal expansion, concentration change in fluid validation/correction using a ratiometric approach comparing expected and measured zero flow measurements, change of fluid in process validation/correction using acoustic properties of a specific fluid, and zero flow correlations/validation based on time of flight and temperature, referenced to historically captured data and the acoustic properties of the fluid in the process.

### RELATED APPLICATION

This application is a continuation of U.S. Utility patent application Ser. No. 17/741,405 for a “High Sensitivity Ultrasonic Flow Meter,” filed May 10, 2022, and currently co-pending, and which claims priority to U.S. Provisional Patent Application Ser. No. 63/186,789 for a “High Sensitivity Ultrasonic Flow Meter,” filed May 10, 2021. The above-mentioned related applications are incorporated herein by reference.

### FIELD OF THE INVENTION

The present invention relates generally to fluid flow sensors. The present invention is more particularly directed to a high sensitivity fluid flow sensor using an ultrasonic sensor pair to determine fluid flow rates.

### BACKGROUND OF THE INVENTION

In detecting flow rates as applied to leak detectors, it is very important to sense even the slightest flow as a leak as small as a few drops a minute can manifest itself over time to a catastrophic loss. As a result, it is advantageous to provide a high sensitivity flow meter.

### SUMMARY OF THE INVENTION

The present invention utilizes an up-stream and down-stream ultrasonic sensor path to determine relative flow based on a differential time-of-flight measurement. Once the base measurement is obtained, a series of mathematical filters are applied to the sensor detection readings to differentiate the signal characteristics from the background noise characteristics. These filters may be accomplished using digital signal processing techniques coupled with a creative architecture for the acoustic sensor chambers in line with the fluid flow to maximize sensitivity. The basic chamber designs and mathematical calculations to determine the flow rates are described herein.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front view of a high sensitivity ultrasonic flow meter;

FIG. 2 is a perspective view of the high sensitivity ultrasonic flow meter shown in use on a test bench;

FIG. 3 is a set of graphs of zero flow measurements from the high sensitivity ultrasonic flow meter;

FIG. 4 is a set of graphs of minimum detectable flow from the high sensitivity ultrasonic flow meter, shown alongside readings from a US meter and pressure and temperature readings;

FIG. 5 is a set of graphs of flow data from the high sensitivity ultrasonic flow meter, shown alongside readings from a US meter;

FIG. 6 is another set of graphs of flow data from the high sensitivity ultrasonic flow meter, shown alongside readings from a US meter;

FIG. 7 is another set of graphs of flow data from the high sensitivity ultrasonic flow meter, shown alongside readings from a US meter;

FIG. 8 is another set of graphs of flow data from the high sensitivity ultrasonic flow meter, shown alongside readings from a US meter;

FIG. 9 is another set of graphs of flow data from the high sensitivity ultrasonic flow meter, shown alongside readings from a US meter;

FIG. 10 is another set of graphs of flow data from the high sensitivity ultrasonic flow meter, shown alongside readings from a US meter;

FIG. 11 is another set of graphs of flow data from the high sensitivity ultrasonic flow meter, shown alongside readings from a US meter;

FIG. 12 is a set of graphs of flow data from the high sensitivity ultrasonic flow meter;

FIG. 13 is a set of graphs showing inverse correlation of pressure and flow;

FIG. 14 is a graph showing the use of signal processing for smoothing the raw data;

FIG. 15 is a diagram of multi-mode fluid detection as performed by the high sensitivity ultrasonic flow meter;

FIG. 16 is a path diagram of acoustic paths through fluid used for the calculation of flow rate;

FIG. 17 is a diagram of transducer mounting configurations;

FIG. 18 is another diagram of paths through fluid;

FIG. 19 is a diagram of transducer mount dimensions;

FIG. 20 is a perspective view of a pipe segment with an exemplary sensor mounting configuration;

FIG. 21 is a perspective view of a pipe segment with another exemplary sensor mounting configuration;

FIG. 22 is a perspective cutaway view of the pipe segment;

FIG. 23 is another perspective view of the exemplary pipe segment configurations;

FIG. 24 is a diagram of a pipe segment showing exemplary transducer and pressure/temperature sensor configurations and fluid flow;

FIG. 25 is a table illustrating exemplary layout and parameter configurations;

FIG. 26 is a flowchart depicting depicting a process of flow analysis using a high sensitivity ultrasonic flow meter;

FIG. 27, FIG. 28, FIG. 29, FIG. 30, FIG. 31, FIG. 32, and FIG. 33 are enlargements of each portion of the flowchart;

FIG. 34 is a table illustrating exemplary flow calibration station layout and calibration parameters; and

FIGS. 35, 36, and 37 are portions of a flowchart depicting a process of flow analysis using a high sensitivity ultrasonic flow meter.

### DETAILED DESCRIPTION

### Ultrasonic Meter

### Overview:

Prototype hardware complete
Prototype electronics complete
Basic firmware complete
Capable of detecting sub drop per second flow*
Capable of “residential” (non class designated metering) based on

single point calibration (˜95% accuracy at 25C) **
Detecting is defined as the ability to determine flow at or above said rate is active, accuracy is not taken into consideration in this range. In other words we are considering this flow region the “leak detection” realm and not metering.
Single point calibration is defined as the following.

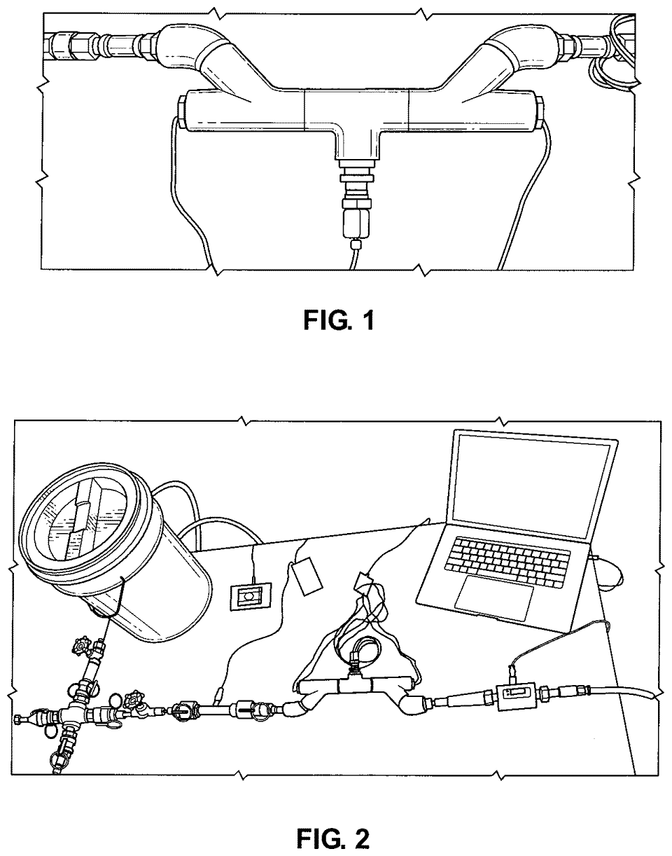

Multipoint metering (when needed) can be implemented to achieve class 1 or 2 metering (see calibration and Appendix) Prototype A prototype meter is illustrated in FIG. 1.

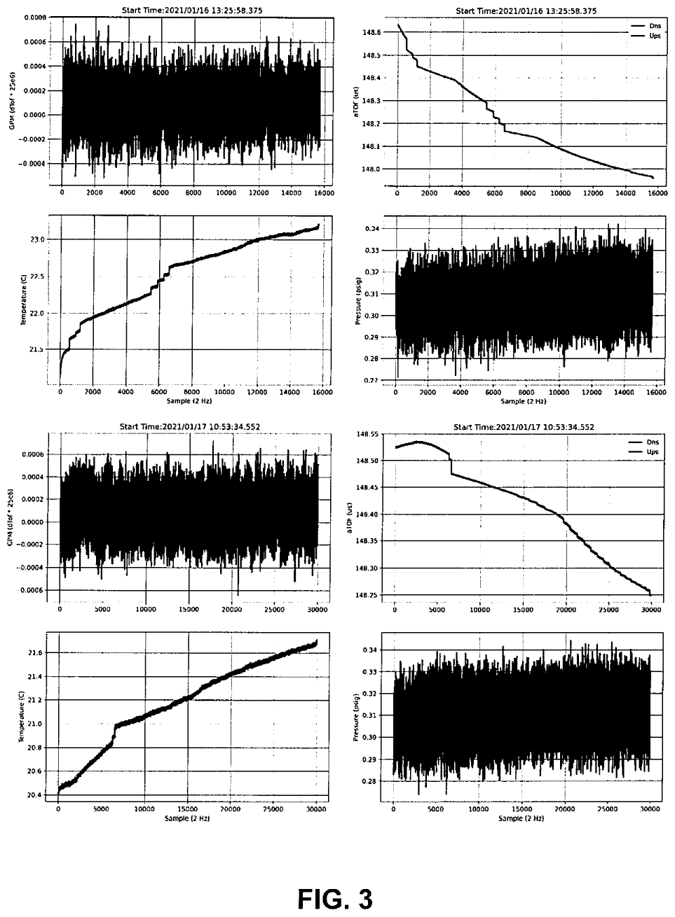

Referring now to FIG. 2, all the graphs in the following figures are generated from data obtained from the prototype ultrasonic meter.

The test bench used was as follows: tank->pump->ref. Meter->US meter->Ids->tank Test bench. Zero Flow

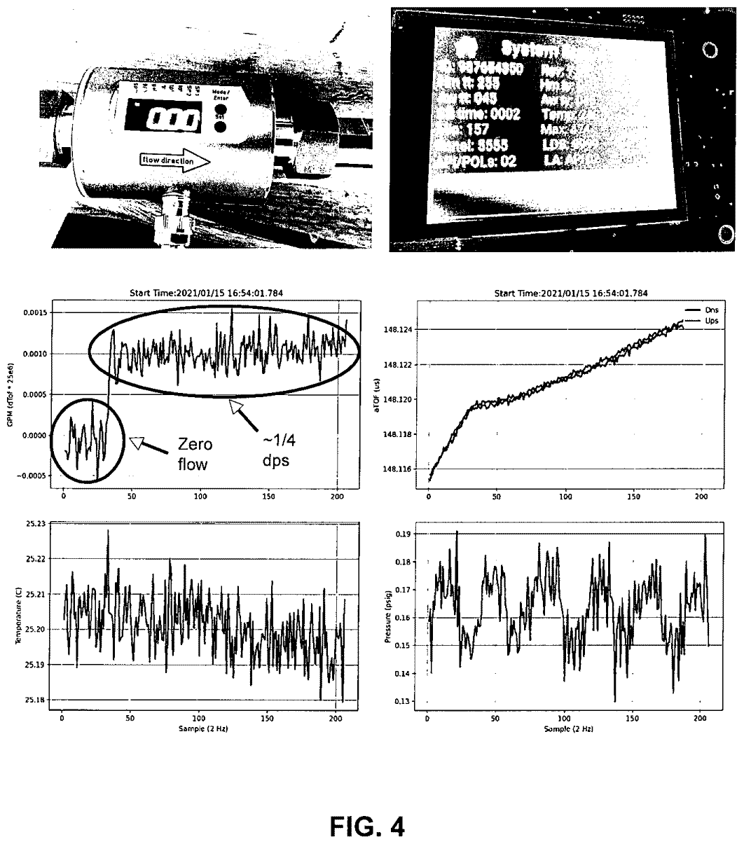

FIG. 3 illustrates zero flow measurements for the ultrasonic (US) meter. Zero flow drift can be seen below for multiple hour periods. This is an important characteristic as it allows us to determine the noise band over a range of temperatures. This is the greatest factor when determining the minimum detectable flow.

### US Minimum Detectable Flow

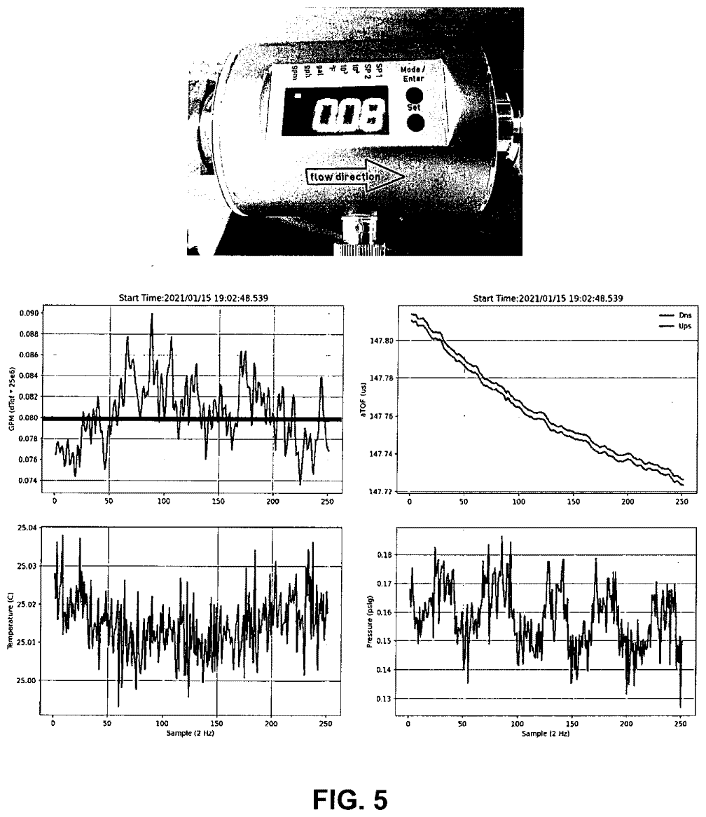

FIG. 4 illustrates about ¼ drop per sec (dps) flow readings for IMF mag meter (undetectable), LDS (undetectable), and US meter respectively.

(LDS and US flow body= 33/4″ npt)

(Pressure and temperature reading from WNK sensor on US i2c bus)

### Flow Data

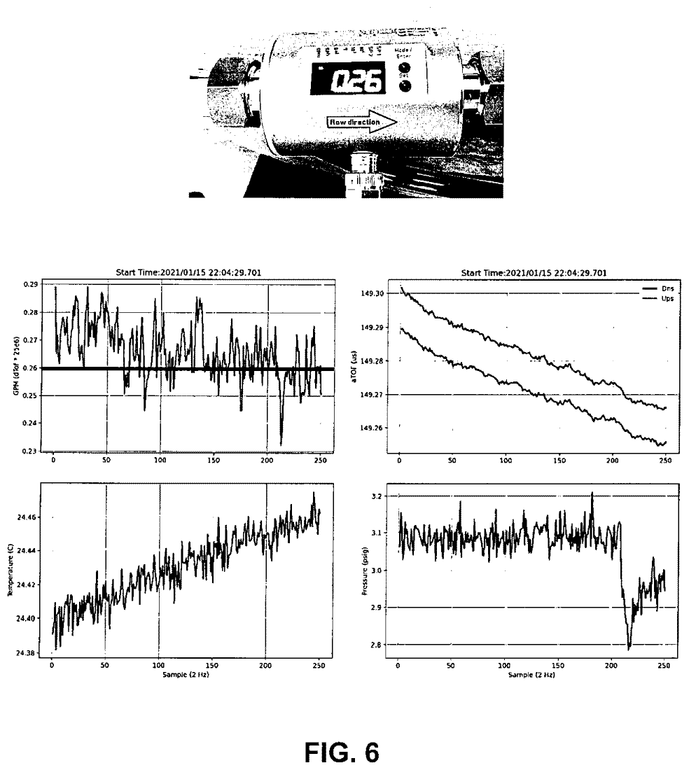

Referring now to FIG. 5, a US meter with single point calibration based on the reference mag meter is shown. Properly Calibrated meter will implement a multi-point multi-temperature calibration capable of achieving class 1 meter status (1% reading accuracy over Q2,Q3,Q4 [see appendix]).

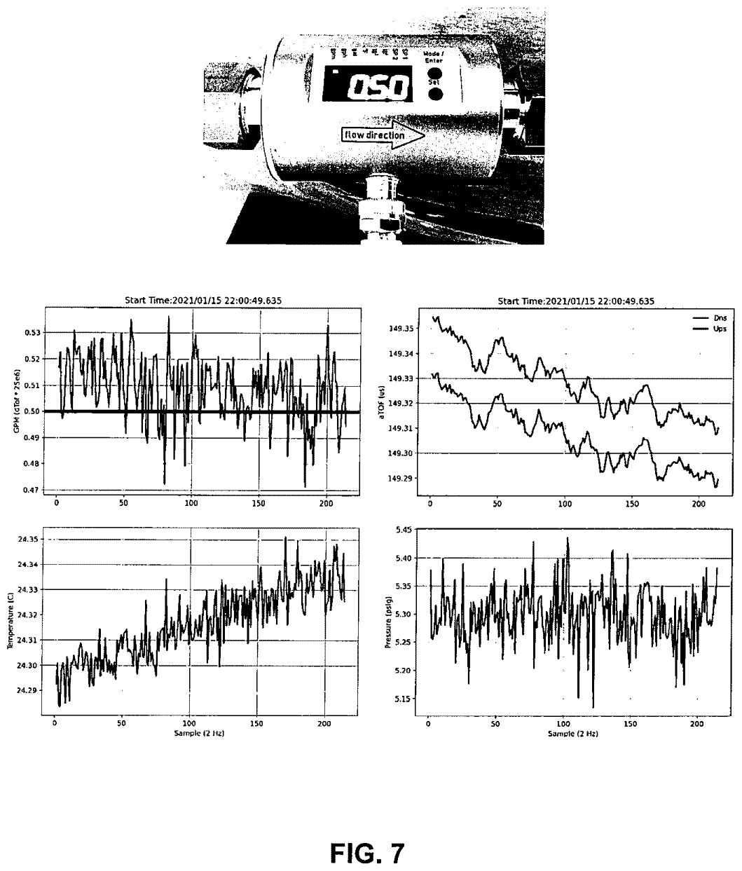

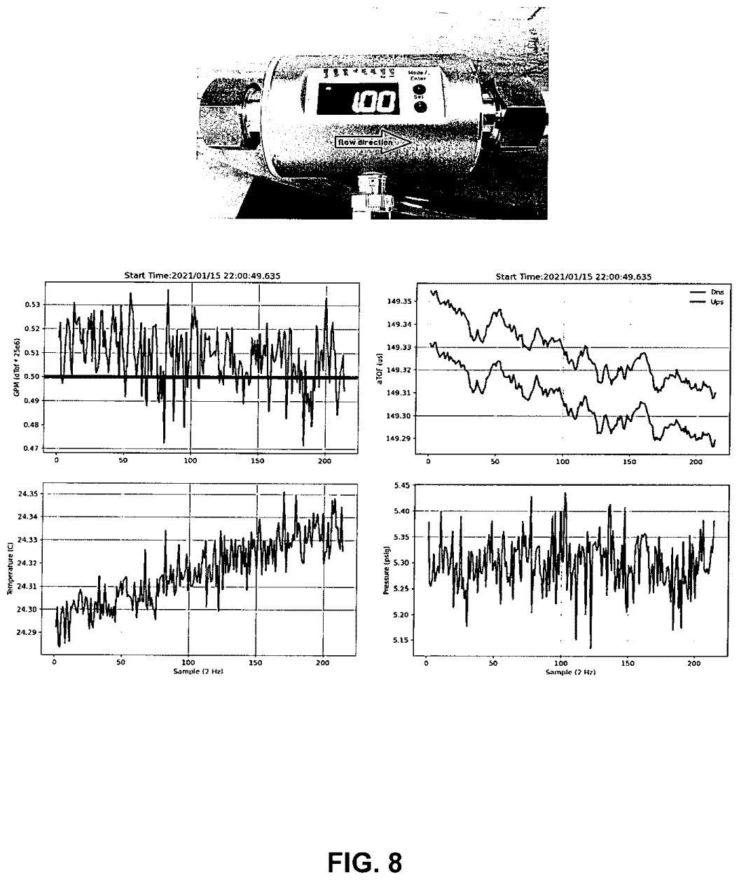

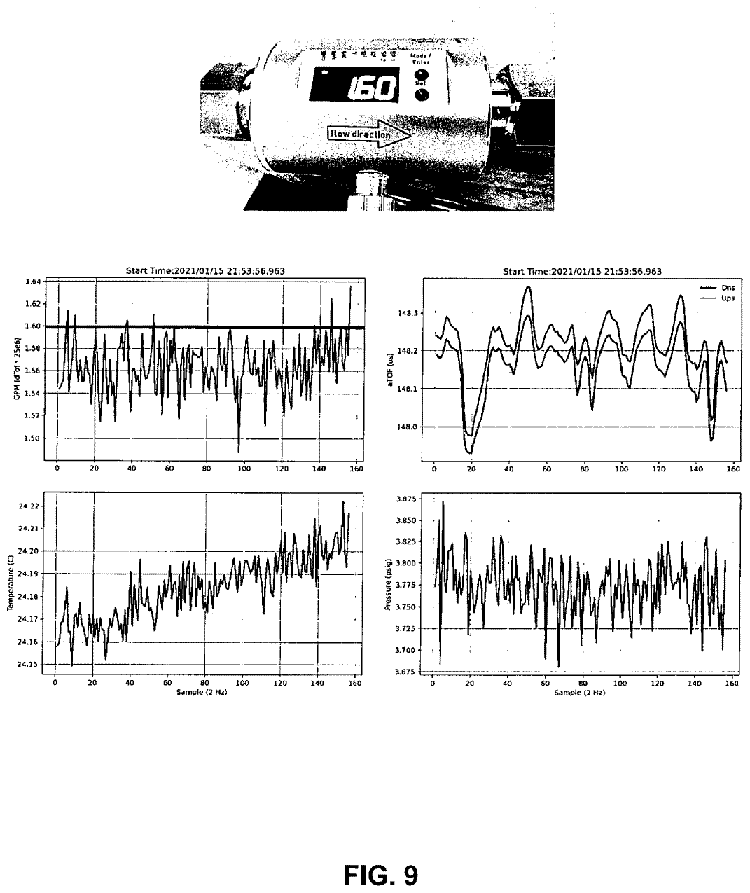

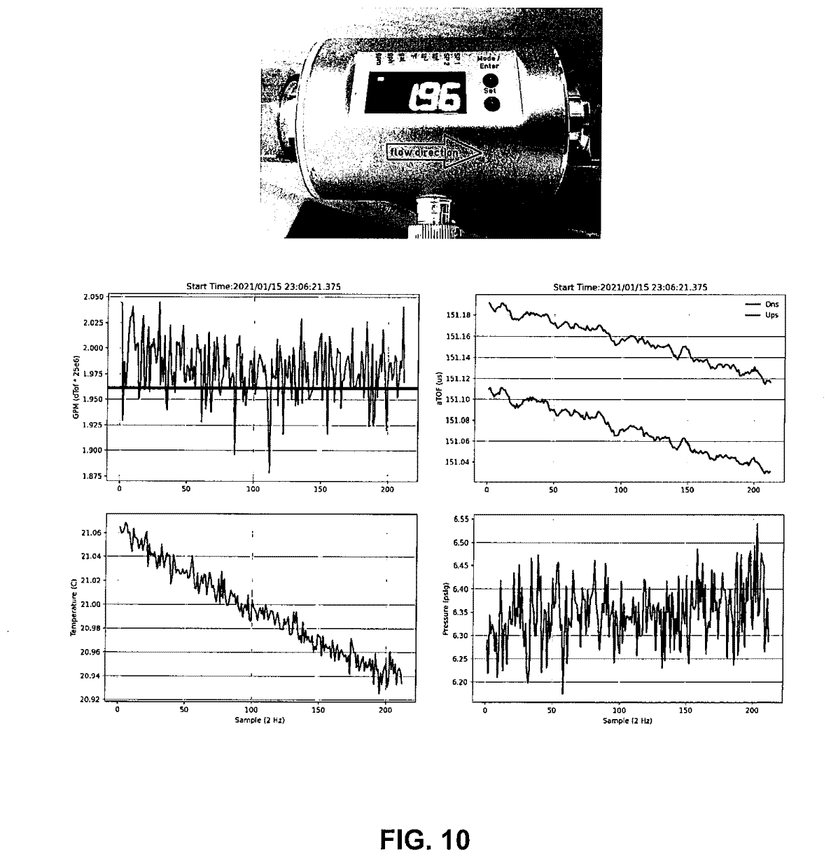

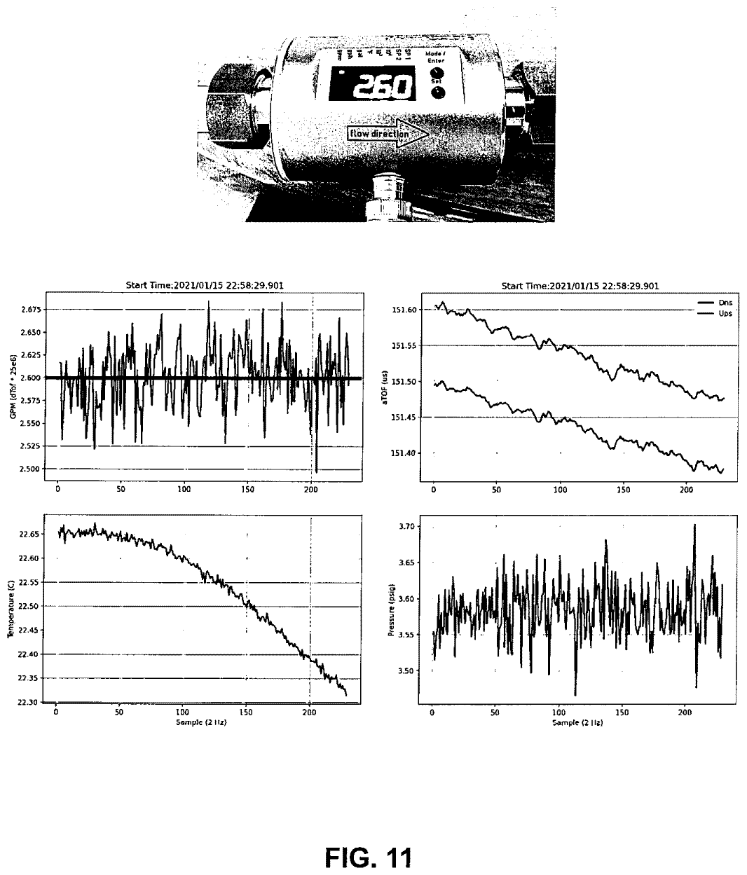

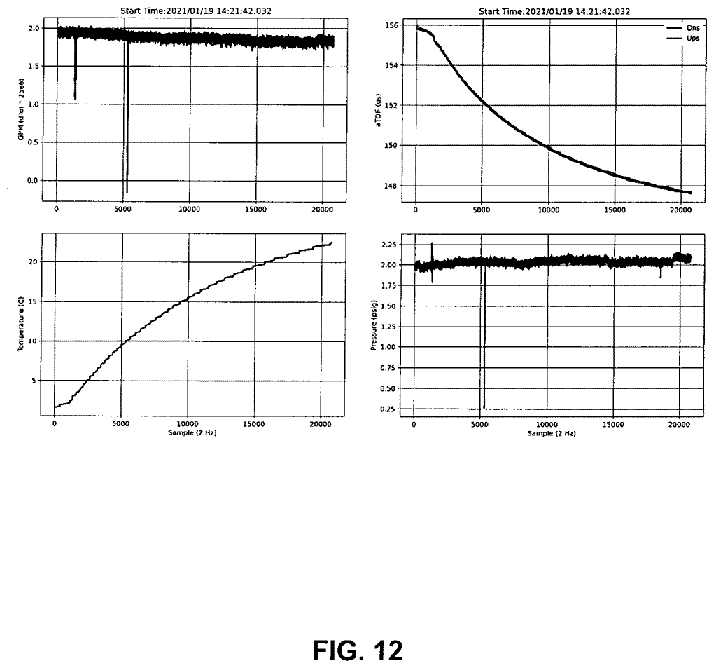

Referring now to FIGS. 6-11, a US meter with single point calibration based on the reference mag meter is shown with various readings.

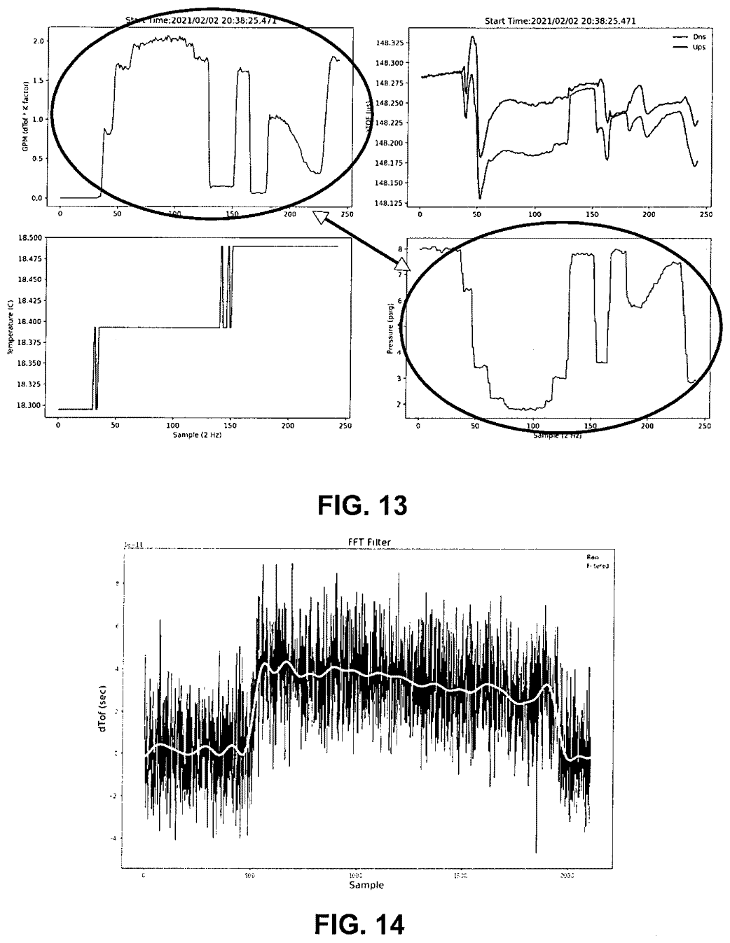

Referring now to FIG. 12, a graph of flow data is illustrated using a US meter with single point calibration based on the reference mag meter over a large temperature range.

Here we can see an approximate drift of around 10% as the temperature ramps up from 1C to 25C.

This drift can be avoided by a multi temperature calibration.

### Pressure Data

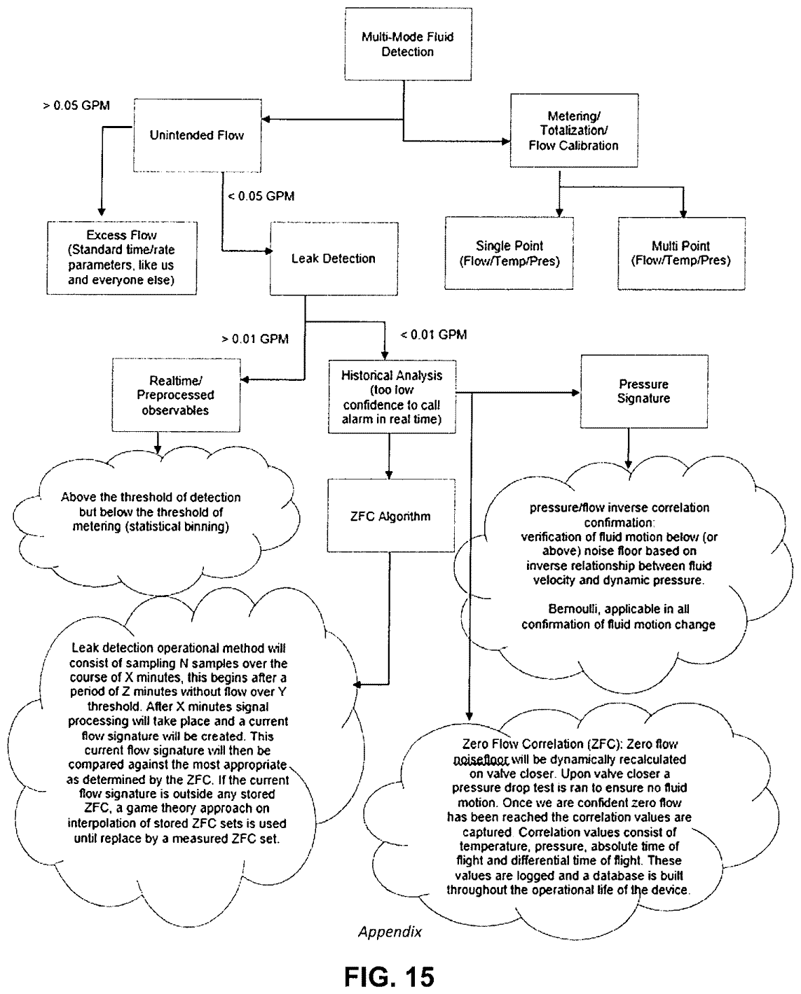

Referring now to FIG. 13, Pressure/flow inverse correlation confirmation is illustrated:

verification of fluid motion below (or above) noise floor based on inverse relationship between fluid velocity and dynamic pressure.

Bernoulli, applicable in all confirmation of fluid motion change.

### Signal Processing

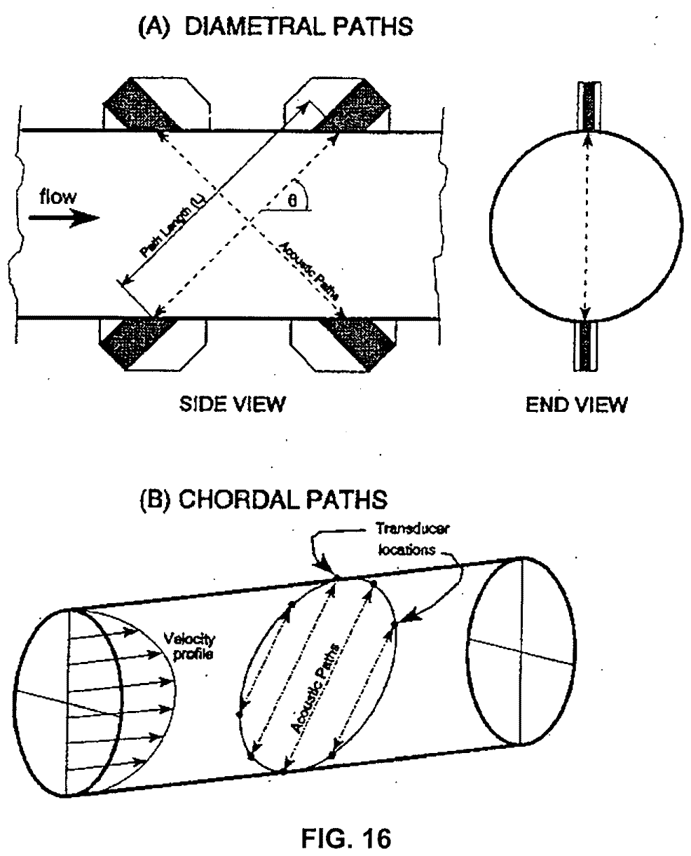

Referring now to FIG. 14, All previous data is raw and direct from the ultrasonic microcontroller. Below we can see an example of data being smoothed using a pseudo real time transform. This is the foundation of many of the algorithms being developed.

The patentable IP will be in the algorithms and sensor correlations that fall out of the data.

### Leak Detection:

Such as the possibility of a frequency measurement of impulses from drops dripping perhaps sinusoidal and using that as the measurement over flow/TOF.

### Metering:

Using special substitution FIR filtering to deal with real time data looking out of place and displaying the corrected current flow rate

Totalization: Using special substitution IIR filtering, to deal with historical data

anomalies that throw off the totalization tally, then calculating or recalculating the tally based on historical and current data sets.

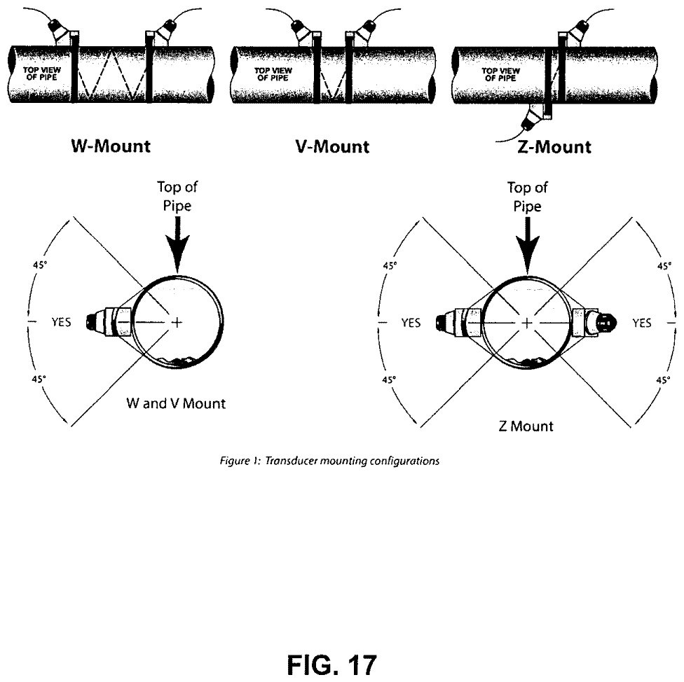

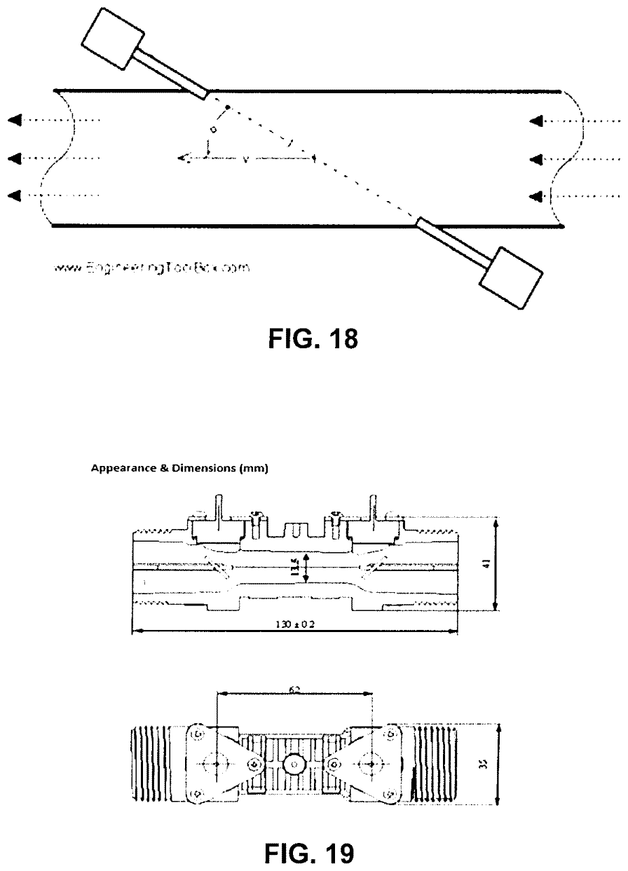

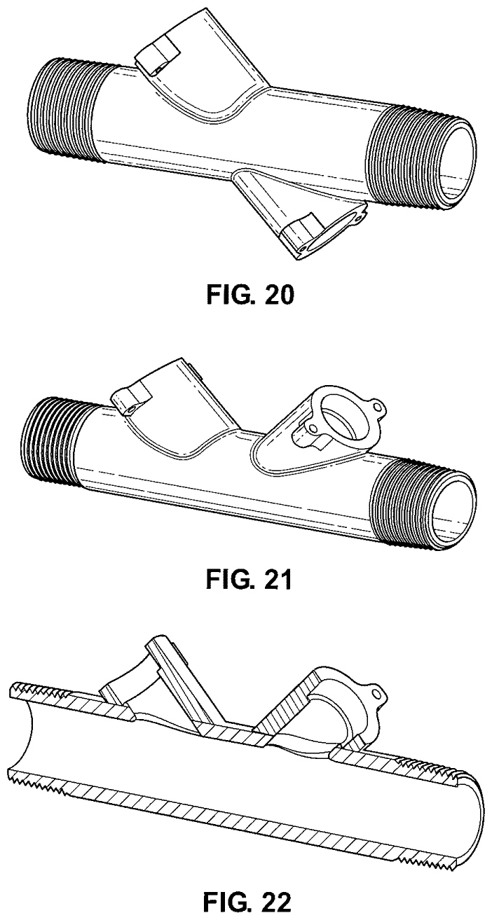

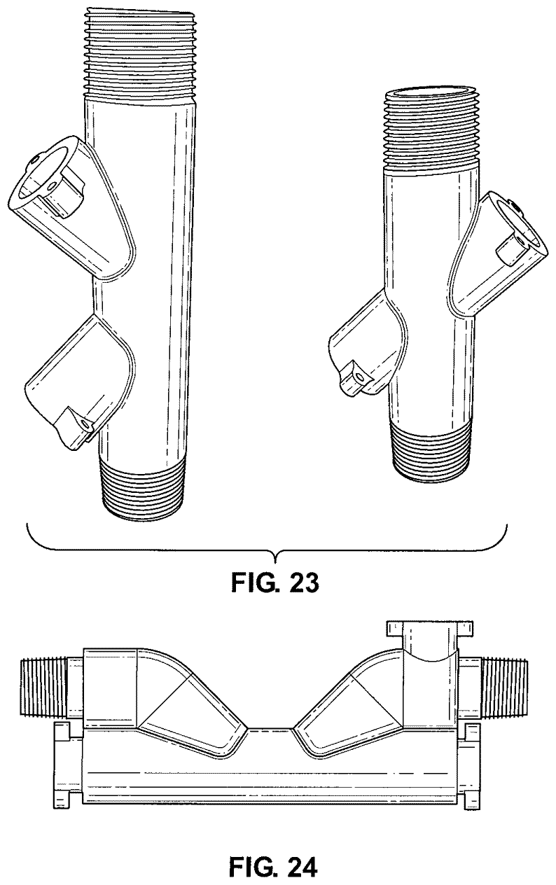

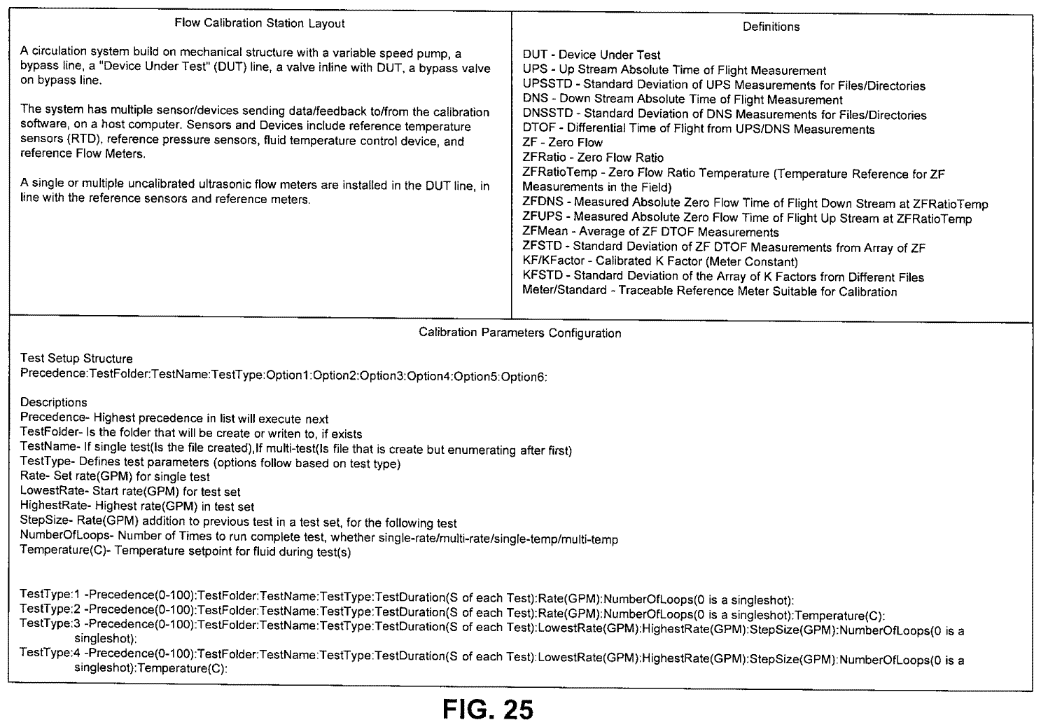

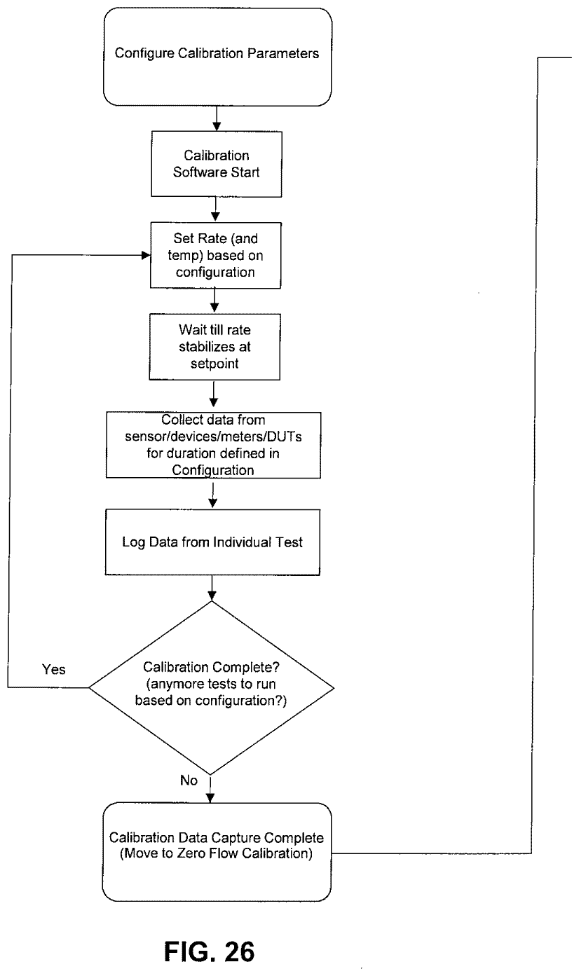

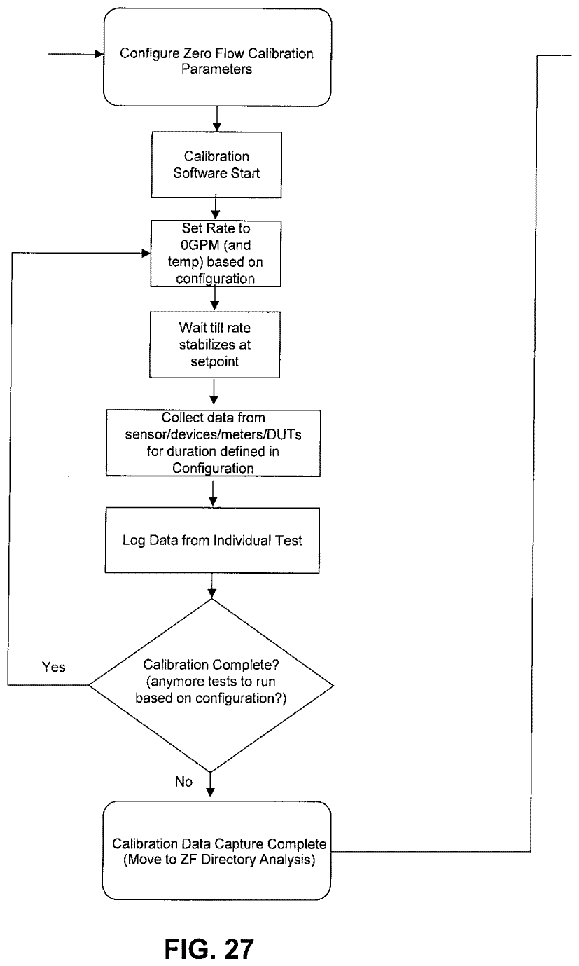

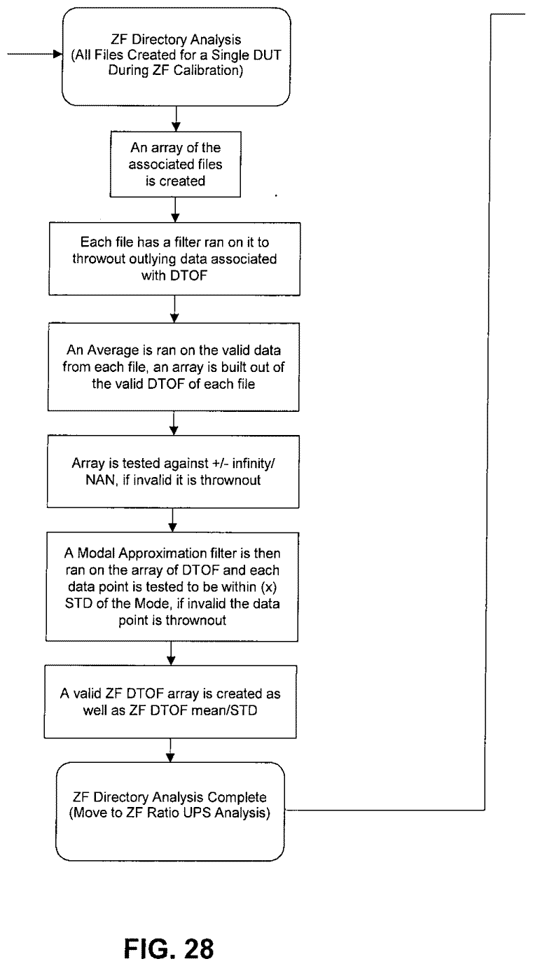

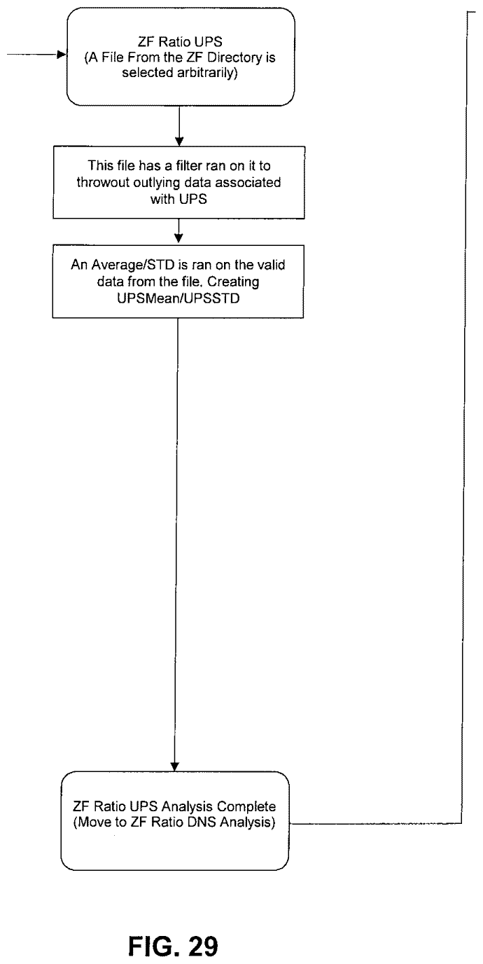

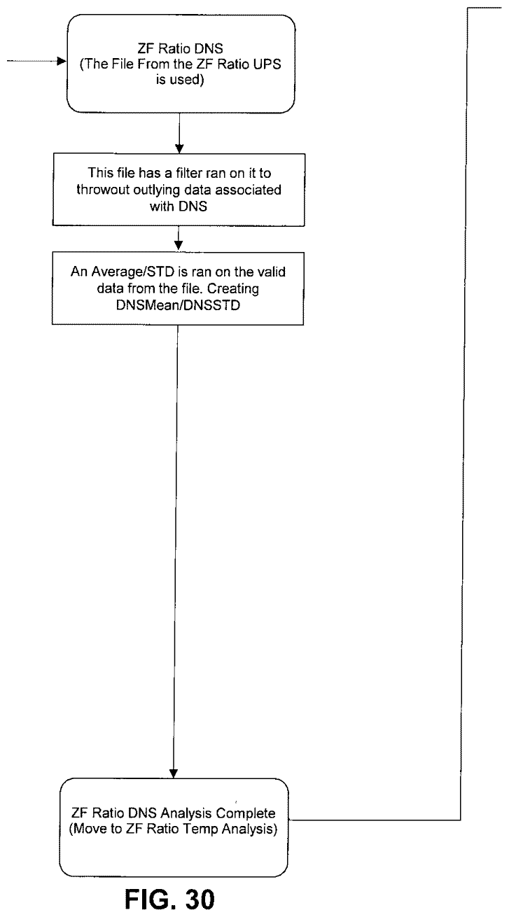

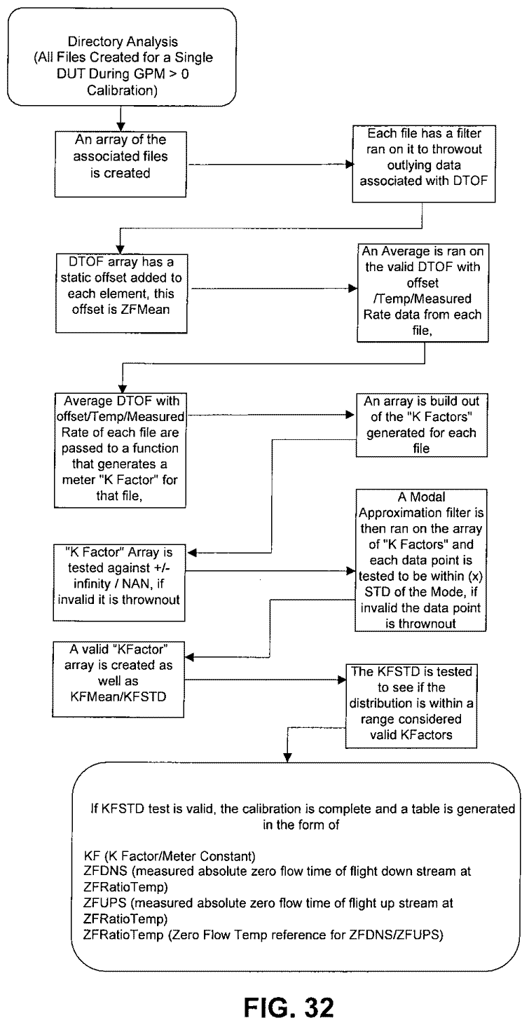

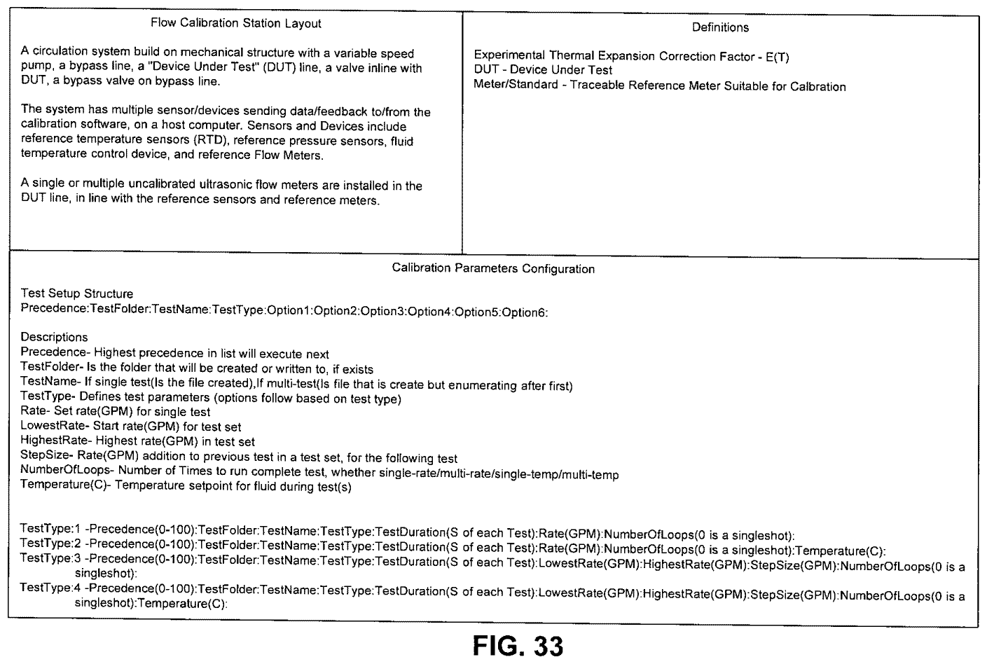

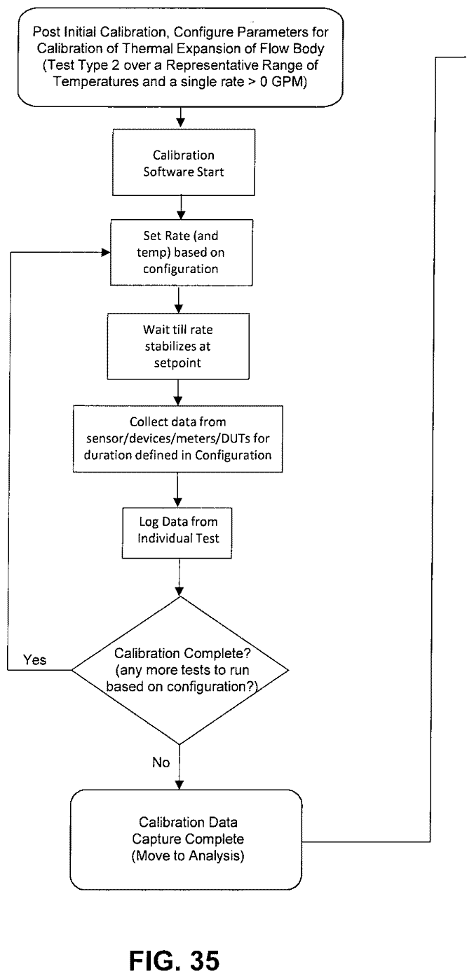

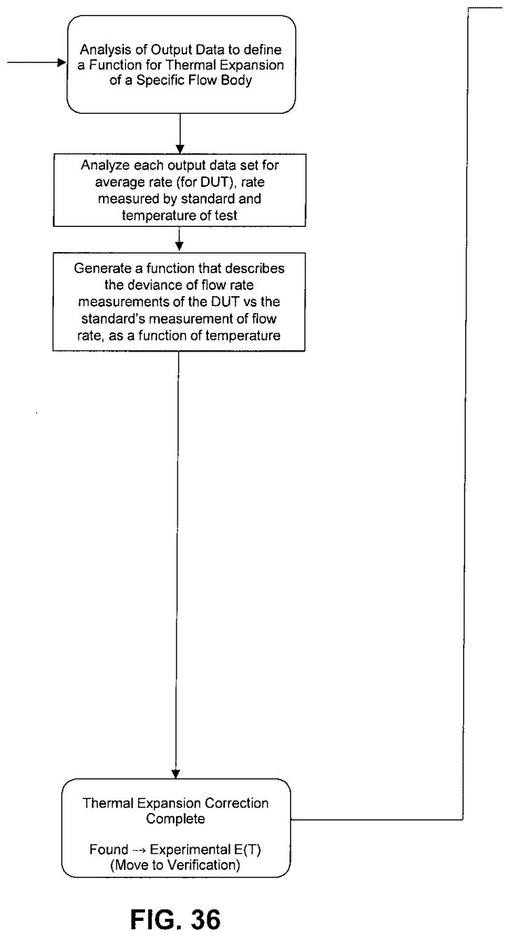

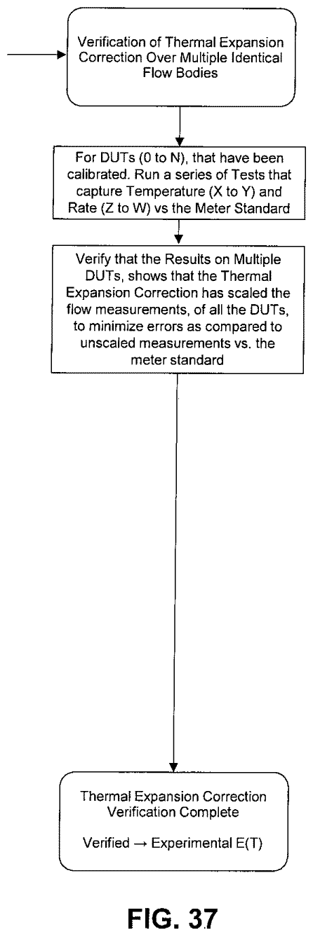

Referring now to FIGS. 15-37 the operation of the invention, its manner of functioning, and analysis of measurement results is illustrated and described in detail as follows below.

### Appendix

### Meter Definition

If the flow meter is intended for residential applications, it must be designed to meet the required standards. For example, per the INTERNATIONAL ORGANIZATION OF LEGAL METROLOGY (OIML), the metrological requirements of water meters are defined by the values of Q1, Q2, Q3 and Q4, which are described in Table 26.

TABLE 26
Flow-rate Zones per OIML

| FLOW- | |
|---|---|
| RATE | |
| ZONE | DESCRIPTION |
| Q1 | Lowest flow rate at which the meter is to operate |
| | within the maximum permissible errors. |
| Q2 | Flow rate between the permanent flow rate and the |
| | minimum flow rate that divides the flow rate range |
| | into two zones, the upper flow rate zone and the |
| | lower flow rate zone, each characterized by its |
| | own maximum permissible errors. |
| Q3 | Highest flow rate within the rated operating |
| | condition at which the meter is to operate |
| | within the maximum permissible errors. |
| Q4 | Highest flow rate at which the meter is to operate |
| | for a short period of time within the maximum |
| | permissible errors, while maintaining its |
| | metrological performance when it is subsequently |
| | operating within the rated operating conditions. |

A water meter is designated by the numerical value of Q3 in m³/h and the ratio Q3/Q1. The value of Q3 and the ratio of Q3/Q1 are selected from the lists provided in the OIML standards.

Water meters have to be designed and manufactured such that their errors do not exceed the maximum permissible errors (MPE) defined in the standards. For example, in OIML standards, water meters need to be designated as either accuracy class 1 or accuracy class 2, according to the requirements.

For class 1 water meters, the maximum permissible error in the upper flow rate zone (Q2≤Q≤Q4) is ±1%, for temperatures from 0.1° C. to 30° C., and ±2% for temperatures greater than 30° C. The maximum possible error for the lower flow-rate zone (Q1≤Q<Q2) is ±3%, regardless of the temperature range.

For class 2 water meters, the maximum permissible error for the upper flow rate zone (Q2≤Q≤Q4) is ±2%, for temperatures from 0.1° C. to 30° C., and ±3% for temperatures greater than 30° C. The maximum possible error for the lower flow-rate zone (Q1≤Q<Q2) is ±5%, regardless of the temperature range.

The flow meter accuracy specified in the standards dictates the required accuracy in the electronics used for driving the ultrasonic transducers, circuits in the receiver path, and time measurement sub circuits. The stringent accuracy required at lower flow rates would require a very low noise signal chain in the transmitter and receiver circuits used in ultrasonic flow meters, as well as the ability to measure picosecond time intervals.

Mathematical Calculations and Determination of Fluid Flow Rates

[symbol]

Variables

| | |
|---|---|
| Q | Flow Rate ( [symbol] ) |
| Q [symbol] | Flow Rate (gpm) |
| Q [symbol] | Measured Flow Rate from Reference Meter (gpm) |
| A | Cross Sectional Area of Flow Body (m²) |
| D | Diameter of Flow Body (m) |
| V | Velocity of Fluid (m/s) |
| Δt | Raw Measurement Differential Time of Flight (s) |
| T | Temperature of Fluid |
| C [symbol] (T) | Characteristic Speed of Sound of Fluid as |
| | a function of Fluid Temperature (m/s) |
| C [symbol] (T) | Characteristic Speed of Sound of Water as |
| | a function of Water Temperature (m/s) |
| L | Length Between Transducers Parallel to Flow (m) |
| K | Calibrated K Factor (m) |
| G | Gallons per Cubic Meter (264.172 gal/m³) |
| E(T) | Thermal Expansion Correction Factor |
| | as a function of Temperature |

[symbol]

indicates data missing or illegible when filed

[symbol]

$$A = \frac{{D}^{2} \text{?}}{4} \qquad ( 1 )$$

$$V = \frac{Δ {t ( {C}_{f} ( T ) )}^{2}}{2 L} \qquad ( 2 )$$

$$Q = AV \qquad ( 3 )$$

$$\text{?} \text{indicates text missing or illegible when filed}$$

[symbol]

$$K = \frac{\text{?}}{\text{?}}$$

$$\text{?} \text{indicates text missing or illegible when filed}$$

[symbol]

$$\begin{matrix}Q = AV \\ = ( \frac{{D}^{2} π}{4} ) ( \frac{Δ {t ( {C}_{f} ( T ) )}^{2}}{2 L} ) \\ = ( \frac{{D}^{2} π}{\text{?}} ) ( Δ {t ( {C}_{f} ( T ) )}^{2} ) \\ = K Δ {t ( {C}_{f} ( T ) )}^{2}\end{matrix} \qquad ( 4 )$$

$$\text{?} \text{indicates text missing or illegible when filed}$$

[symbol]

$$K = \frac{Q \text{?}}{\text{?}} \qquad ( 5 )$$

$$\text{?} \text{indicates text missing or illegible when filed}$$

[symbol]

$$Q = {( C \text{?} ( T ) )}^{2} Δ tK = \frac{Q \text{?}}{\text{?}} \qquad ( 6 )$$

$$\text{?} \text{indicates text missing or illegible when filed}$$

[symbol]

$$Q = {( {C}_{f} ( T ) )}^{2} Δ tK = \frac{Q \text{?}}{\text{?}} \qquad ( 7 )$$

$$\text{?} \text{indicates text missing or illegible when filed}$$

[symbol]

$$Q = {( {C}_{f} ( T ) )}^{2} Δ tKE ( T ) \qquad ( 8 )$$

1. In the ultrasonic calibration procedure flow diagram, because of the approach to calculating flow rate with a dynamic temperature feedback, automatically adjusting the Cf magnitude in the flow rate equation and Cf encapsulating the temperature dependence of the measurement. (1) A single point (or multi point) calibration can be run agnostic to temperature of the fluid as long as the temperature is captured (2) while still yielding industry leading tolerances because the governing equations used for flow rate are a direct relation to the fundamental principles for acoustic propagation in fluids. (3) The novelty of this procedure is that a device can be calibrated with a single point (or multi point) calibration but hold tolerances full span, there is not polynomial fit or lookup table (based on flow measurements vs temperature), instead the acoustic propagation speed correction factors are held directly in the Cf, as the only dependence is temperature after the K factor encapsulates the Length and Diameter dependence of the equation.

2. If a fluid change is known to have taken place, by design of the user, and the fluid is known. Rather than allowing the device to automatically create a shift in measurements based on the single point zero flow/known temperature measurements from the factory. (1) The user can instead input the new characteristic equation Cf, for the new fluid with a different Cf, and still maintain factory calibration for a new fluid. Assuming characteristic Cf polynomial is known.

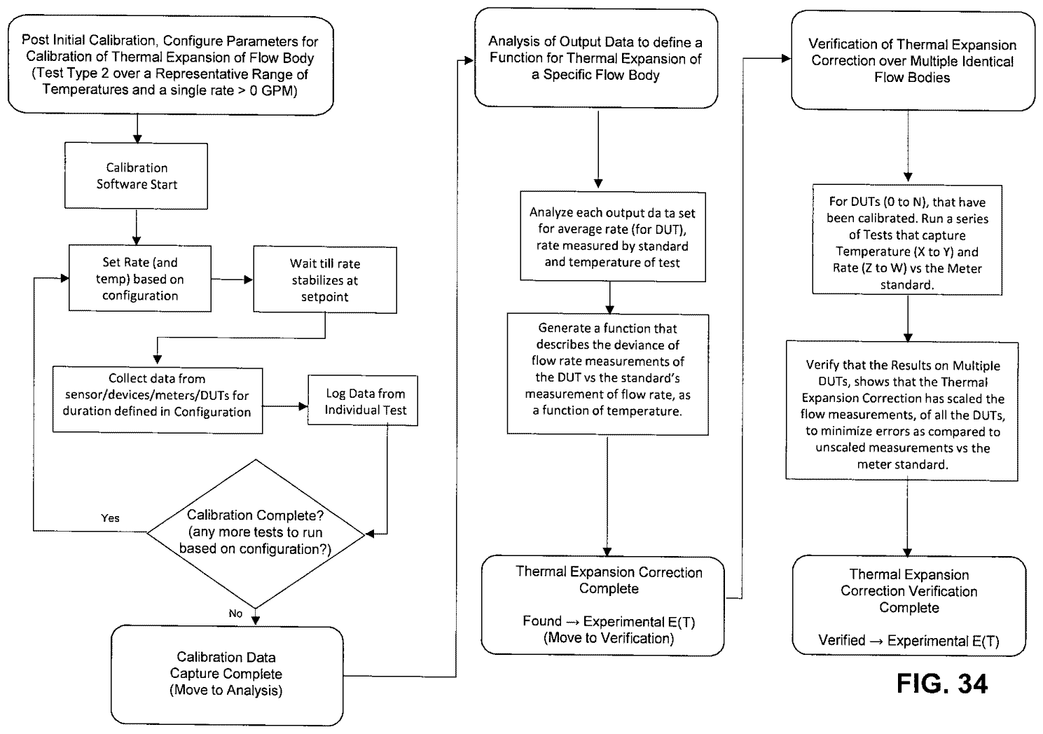

3. See FIG. 34. For a given flow body, a single point calibration can be ran to create the K factor associated with a DUT. Post initial calibration, a series of measurements can be taken at the same flow rate, referenced against a meter standard, over a range of temperatures. (1) By analysis of the deviation between the measurements of the standard and the device under test, across the temperature range measured, a function can be generated to describe the characteristic thermal expansion of the flow body. (2) This function can be used in conjunction with the single point calibration (solved K factor), as a scalar to the flow rate, based on thermal expansion, which in conjunction with the K factor contains the dependence of length parallel flow between transducers and diameter of the flow body, for the governing equation for flow rate in ultrasonic flow metering. This function generated, can be tested across a series of identically manufactured flow bodies to ensure the validity. When the validity of this function is ensured, each DUT, manufactured under the same conditions, can use this function in the calibration procedure without the need to regenerate the function for each flow body under test. (3) Meaning once this function is generated for one device, following devices that have a single point calibration, can use the adapted function to account for thermal expansion.

### Other Claims

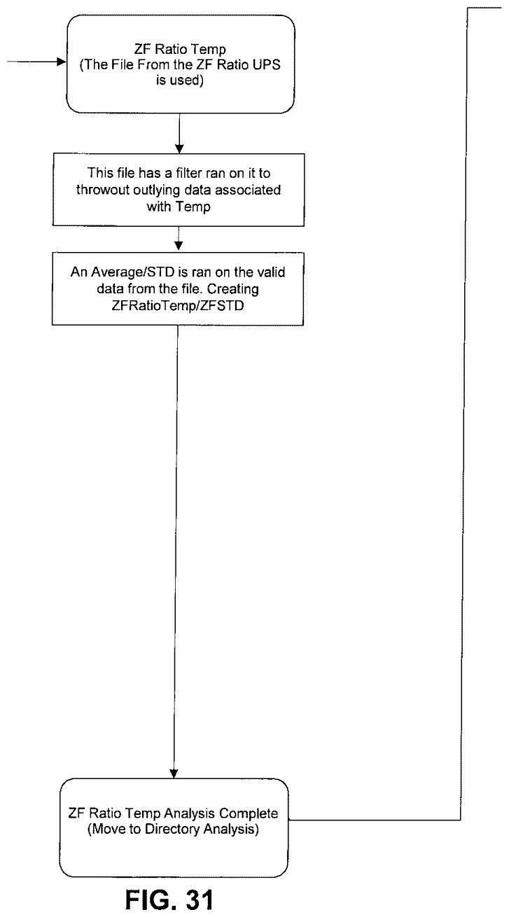

4. During the Calibration, a zero flow measurement is captured (see FIG. 25, Expressions 6,7,8). The measurements associated are absolute time of flight up stream and down stream (from the ultrasonic meter), as well at a high resolution temperature measurement of the fluid at that time. These measurements are logged to the device to be used as a way to test the fluid that the device is installed in during operation, with these parameters logged the device will be able to (1) test the fluid the device is installed compared the fluid it was calibrated/configured to measure by closing a valve and sampling zero flow absolute time of flight up stream and down stream, as well as temperature. These current measurements will be compared to the equivalent measurements taken during calibration. Both calibration and current zero flow measurements are tested by passing the values into a function that scales the time of flight measurements based on Temperature and the polynomial for Cf. This gives a fundamental reference to the expected absolute time of flight measurements at the current temperature of the fluid, based on the factory stored values. If there is deviation outside of the expected tolerance, (2) the device can acknowledge a fluid change as compared to the calibration fluid, the ramifications of fluid change are relevant to accuracy and process control feedback.

5. For fluids that share a similarly shaped Cf curve and for a meter that has acknowledged a change in fluid (see ZF section of FIG. 25), (1) devices can automatically begin multiplying measurements by a ratiometric scalar in perceived measurements to recalculate measurements from the observed zero flow shift, based on the single point zero flow/known temperature measurements from the factory. In an attempt to mitigate errors in perceived flow rate versus actual flow rate, after a fluid or fluid concentration change.

6. When the meter is installed in an environment where not only flow rate is important but also the health of the plumbing system (see ZF section of FIG. 25), in terms of whether or not a leak exists in pumping or valving. The device will take a measurement at a regular interval of temperature and absolute TOF UPS/DNS, when the device perceives no flow or a rate below metering resolution. The Device will then compare this information with both the last know valve closure zero flow correlation and factory zero flow correlation. (1) This allows the device to check if the current perceived zero flow (with valve open) is above binned tolerance of fluid movement, disconnecting quantitative rate with qualitative movement. (2) Which allows for notification of leak conditions below the metering threshold, while maintaining no claims to meter at this binned threshold, allowing the meter “class/classification” to be maintained while giving feedback to user below the meter's resolution of flow. (3) Allowing for leak detection capabilities in a realm that previously, in this industry, only pressure drop tests could detect. (4) If the movement perceived is in a bin below the tolerance of certain movement, a valve is closed for a direct comparison of zero flow versus current perceived movement, as well as an optional cross correlation with pressure drop assessment from a high resolution pressure sensor measurement over time, with the valve closed.

What is claimed is:

1. A metering apparatus, comprising:
a high sensitivity ultrasonic flow meter, comprising:
a fluid pathway comprising an acoustic sensor chamber,
an upstream ultrasonic sensor,
a downstream ultrasonic sensor, and
an ultrasonic microcontroller;
wherein the upstream sensor emits an upstream ultrasonic signal into the fluid pathway, the upstream ultrasonic signal detected by the downstream sensor, resulting in a determination of upstream time of flight;
wherein the downstream sensor emits a downstream ultrasonic signal into the fluid pathway, the downstream ultrasonic signal detected by the upstream sensor, resulting in a determination of downstream time of flight; and
wherein the ultrasonic microcontroller is configured to perform a determination of fluid flow rate based on the upstream time of flight and the downstream time of flight, the determination of fluid flow rate using a calibrated factor for a fluid type selected from a plurality of fluid types multiplied by a characteristic polynomial for the plurality of fluid types.

2. The metering apparatus of claim 1, wherein the calibrated factor for the fluid type is obtained from a single point calibration.

3. The metering apparatus of claim 1, wherein the calibrated factor for the fluid type is obtained from a multi-point calibration.

4. The metering apparatus of claim 1, wherein the characteristic polynomial contains acoustic propagation speed correction factors, allowing the ultrasonic flow meter to maintain industry standard tolerances at different temperatures with temperature-agnostic calibration.

5. The metering apparatus of claim 1, wherein the high sensitivity flow meter is configured to perform a zero flow correlation routine during leak detection.

6. The metering apparatus of claim 5, wherein the zero flow correlation routine occurs after a predetermined time without flow over a predetermined threshold.

7. The metering apparatus of claim 5, wherein the zero flow correlation routine comprises the creation of a current flow signature by signal processing performed on a plurality of samples taken over a predetermined period of time.

8. The metering apparatus of claim 7, wherein the zero flow signature created by the zero flow correlation routine is compared with stored zero flow correlation, and when the flow signature is outside the stored zero flow correlations, game theory is used for interpolation of the stored zero flow correlations.

9. The metering apparatus of claim 5, wherein the high sensitivity flow meter is configured to acknowledge a fluid change when the zero flow correlation routine results in a deviation outside of expected tolerance from measurements taken during calibration.

10. The metering apparatus of claim 9, wherein acknowledgment of the fluid change causes the high sensitivity flow meter to attempt to mitigate errors in flow rate measurement by automatically multiplying measurements by a ratiometric scalar.

11. A leak detection apparatus, comprising:
a high sensitivity ultrasonic flow meter, comprising:
a fluid pathway comprising an acoustic sensor chamber,
an upstream ultrasonic sensor,
a downstream ultrasonic sensor, and
an ultrasonic microcontroller;
wherein the upstream sensor emits an upstream ultrasonic signal into the fluid pathway, the upstream ultrasonic signal detected by the downstream sensor, resulting in a determination of upstream time of flight;
wherein the downstream sensor emits a downstream ultrasonic signal into the fluid pathway, the downstream ultrasonic signal detected by the upstream sensor, resulting in a determination of downstream time of flight; and
wherein the high sensitivity flow meter is configured to perform a zero flow correlation routine during leak detection.

12. The leak detection apparatus of claim 11, wherein the zero flow correlation routine occurs after a predetermined time without flow over a predetermined threshold.

13. The leak detection apparatus of claim 12, wherein the zero flow correlation routine comprises the creation of a current flow signature by signal processing performed on a plurality of samples taken over a predetermined period of time.

14. The leak detection apparatus of claim 13, wherein the zero flow signature created by the zero flow correlation routine is compared with stored zero flow correlation, and when the flow signature is outside the stored zero flow correlations, game theory is used for interpolation of the stored zero flow correlations.

15. The leak detection apparatus of claim 14, wherein the high sensitivity flow meter is configured to acknowledge a fluid change when the zero flow correlation routine results in a deviation outside of expected tolerance from measurements taken during calibration.

16. The leak detection apparatus of claim 15, wherein acknowledgment of the fluid change causes the high sensitivity flow meter to attempt to mitigate errors in flow rate measurement by automatically multiplying measurements by a ratiometric scalar.

17. The leak detection apparatus of claim 16, wherein the high sensitivity ultrasonic flow meter is configured to perform a single point calibration resulting in a calibrated factor.

18. The leak detection apparatus of claim 17, wherein a characteristic polynomial is multiplied by the calibrated factor in determining fluid flow rate, thereby allowing for measurement of different fluids with similar characteristic polynomial curves.

19. A leak detection apparatus, comprising:
a high sensitivity ultrasonic flow meter, comprising:
a fluid pathway comprising an acoustic sensor chamber,
an upstream ultrasonic sensor,
a downstream ultrasonic sensor, and
an ultrasonic microcontroller;
wherein the upstream sensor emits an upstream ultrasonic signal into the fluid pathway, the upstream ultrasonic signal detected by the downstream sensor, resulting in a determination of upstream time of flight;
wherein the downstream sensor emits a downstream ultrasonic signal into the fluid pathway, the downstream ultrasonic signal detected by the upstream sensor, resulting in a determination of downstream time of flight; and
wherein the high sensitivity flow meter is configured to dynamically recalculate a zero flow noise floor upon closure of a valve using a pressure drop test.

20. The leak detection apparatus of claim 19, wherein the high sensitivity flow meter is configured to detect a leak below a metering threshold by checking whether current perceived zero flow is above a predetermined tolerance of fluid movement.
